(19) United States
(12) Patent Application Publication
(10) Pub. No.: US 2012/0184654 A1
(43) Pub. Date: Jul. 19, 2012

(54) HIGH VISCOSITY SPRAY EMULSION CONCRETE RELEASE AGENT

(75) Inventors: Hida Hasinovic, Lexington, KY (US); Rob Sels, Strijen (NL); Edwin Buysman, Rotterdam (NL)

(73) Assignee: ASHLAND LICENSING AND INTELLECTUAL PROPERTY LLC, Dublin, OH (US)

(21) Appl. No.: 13/324,495

(22) Filed: Dec. 13, 2011

Related U.S. Application Data
(60) Provisional application No. 61/432,943, filed on Jan. 14, 2011.

(51) Int. Cl. C08K 5/101; B28B 7/36

(52) U.S. Cl. 524/315; 264/338

(57) ABSTRACT

A release agent for concrete includes water, a vegetable oil or animal derived oil ester and a polymeric thickener. The composition can either be a direct release agent wherein the composition is a water-in-oil emulsion or an indirect release agent which is an oil-in-water emulsion. The indirect agent may further include vegetable oil wetting agents and biocides. The release agent does not include typical surfactants such as anionic surfactants, cationic surfactants, zwitterionic surfactants, nonionic surfactants, or amphoteric surfactants.

### BACKGROUND OF THE INVENTION

Concrete release agents are used to prevent curing concrete from adhering to a mould surface as it cures. These release agents are typically applied to the surface of the mould and provide a liquid barrier as the concrete is applied and cures. The release agent prevents the curing concrete from forming a bond with the mould surface.

Concrete release agents can be either direct release agents or indirect agents. Direct release agents, are sprayed onto a mould and concrete is poured into the mould. The mould is vibrated for a short period of time, for about a minute, and then the mould is separated from the concrete which retains its shape. Thus, the concrete directly contacts the release agent.

An indirect release agent is used typically, for example, in foundations and concrete reinforced structures. The release agent is applied to the mould surface. The oil will separate from the emulsion. The concrete is introduced into the mould and allowed to set for an extended period of time, such as 12 to 24 hours, or more. After the concrete sets, the mould is separated from the concrete. The oil acts as a barrier keeping the concrete from bonding to the mould surface.

In either application, it is important that the release agent has adequate viscosity and adhesion to remain where applied on the mould surface, not discolor the concrete, and, of course, not create any damage to the surface of the concrete.

For the most part, release agents are formed from petroleum based products. In addition to the adverse environmental impact of these petroleum based products, they can also cause health issues with certain individuals.

Certain emulsions have been suggested for use as concrete release agents. However, typically, oil and water emulsions include surfactants which can react with the concrete causing either air holes or improper curing.

### SUMMARY OF THE INVENTION

The present invention is premised on the realization that an oil and water emulsion formed from vegetable or animal oil esters can be used as a release agent for concrete moulds. More particularly, the present invention uses a polymeric thickening agent to establish an oil and water emulsion. The thickening agent further assists in establishing a desired viscosity to enable the coating to properly coat the mould surface while, at the same time, allowing the coating composition to be applied using a spray apparatus.

In addition to the vegetable or animal derived oil ester and polymeric thickener, the present invention can further include various other oils as well as wetting agents and biocides.

The coating composition of the present invention can either be an oil-in-water emulsion formulated to provide an indirect release agent or a water-in-oil emulsion best used for a direct release agent. This is achieved without the addition of conventional surfactants and instead a polymeric acrylate is used at very low concentration to form both types of emulsions, oil-in-water and water-in-oil.

The objects and advantages of the present invention will be further appreciated in light of the following detailed description:

### DETAILED DESCRIPTION

According to the present invention, a release agent useful to prevent curing concrete from adhering to the surface of a mould, such as the form for a foundation, will include water, an alkyl ester of a natural oil such as vegetable oil or an animal fat/oil, and a polymeric thickener. Optionally, it may further include vegetable oil, wetting agents and biocides. In this application, wherever the term “concrete” is used it is also intended to represent mortar or other cementitious products, including cement.

Any ester of natural oil can be used in the present invention as long as the product is liquid at 0° C. These can be formed from a variety of different natural oils including corn oil, linseed oil, rape seed oil, palm oil, and the like, or animal derived oils. Generally, there will be C₅-C₁₂ alkyl esters. One suitable vegetable oil is Radia 7961, which is sold by Oleon. This product is an alkyl ester of rape seed oil. Another commercially available vegetable oil ester is sold by Argos Oil. Methyl soyate and ethyl lactate esters sold by Stephan Company can also be used.

Also suitable for use in place of or in combination with the vegetable oil esters are esters of animal fats or oils. These animal oil esters must also be liquid at 0° C. Biodiesel is an alkyl ester of vegetable oil and/or animal oil or fat and can be used in the present invention. Vegetable oil esters are particularly suitable for this invention.

The polymeric thickener is an addition polymer of unsaturated carboxylic acids and/or anhydrides. Typically, these will be polyacrylates, or polyalkylacrylates, such as polymethacrylate as well as maleic anhydride. These will generally have a molecular weight range from about 500,000 to about 4 million. A thickener that has a molecular weight of around 1 million to 4 million should function well in the present invention.

Typically, these can be copolymers of acrylates and methacrylates, or copolymers of acrylic acid and alkylmethacrylate. The manufacture of these thickeners is disclosed, for example, U.S. Pat. No. 5,373,044, the disclosure of which is hereby incorporated by reference. These are also discussed in US published application US2009/0253862 A1, the disclosure of which is also incorporated herein by reference. In the present invention, the neutralized form of the thickener is utilized.

One such polymeric thickener which is particularly suitable for use in the present invention is Solagum USPI, a polymeric acrylic emulsifier commercially available from Seppic. This polymeric acrylate based emulsifier is sold in a pre-neutralized form. This polymer thins under shear and can therefore be used in a formulation which is applied by spraying. Other suitable commercially available polymeric thickeners include Pemulen TR-1, Pemulen TR 2 and Novemer EC-1 from Lubrizol.

The emulsions of the present invention can have a viscosity of from about 350 to about 5000 mPas, which can be controlled by the ratio of water to ester as well as the concentration of the polymeric thickener. Generally, on an actives basis by weight, there will be about 0.01-2% polymeric thickener.

The present invention can further include vegetable oil in an amount from about 0 to about 10%, generally 1 to 5% by weight. Any vegetable oil that is liquid at 0° C. can be used in the present invention. Vegetable oil can be added to the composition to establish an oil-in-water emulsion. One suitable commercially available vegetable oil is fully refined rapeseed oil provided by various suppliers. Radiamould 8200 is an optimized mix of fatty esters. It provides excellent film forming properties in the mould, water repellency, good resistance to vibrations and stainless concrete. This is available from Oleon, but can be replaced with other similar vegetable ester blends from different suppliers.

The present invention can further include super wetting agents. These are generally silicone based compositions. One such super wetting agent is BYK 349, sold by BYK Chemie. Another suitable wetting agent is sold by Dow Corning under the name Q 2-5211, which is a low molecular weight nonionic silicone polyether surfactant.

The present invention can also include any suitable biocide such as Proxel BD 20 supplied by Arch Chemicals and used for anti-microbial activity against bacteria yeast and molds. Other suitable biocides such as Kathon, Neolone, Bioban, and Dowicil can also be used.

The present invention can be formulated as either a direct or an indirect concrete release agent. A direct release agent is applied to the mould and concrete immediately contacts the coated mould surface. Generally, the mould is separated from the concrete shortly after contact. In an indirect application, the release agent is applied to the mould surface, the oil is allowed to separate and, subsequently, the concrete contacts the mould surface.

With a direct concrete release agent, a water-in-oil emulsion is preferred. This will include deionized water, the polymeric thickener, and the natural oil ester. Lower concentrations of water relative to ester are preferred. The direct formulation can include about 40% to 70% by weight of ester, more particularly 45% to 60% by weight, and even more particularly 50% to 60% by weight. Generally, the weight ratio of the water to oil ester will be up to 60:40. A ratio of 50:50 provides better release characteristics. A ratio of 40:60 water to ester provides even superior surface characteristics, including color profile. With higher concentrations of water, an increased number of air holes are observed in the surface of the concrete.

Other components that can be added to the direct release agent include a vegetable or animal derived oil, a wetting agent, a biocide, a petroleum solvent and a hydrophobic siloxane. The biocide is added in an amount effective to prevent bacterial and mould growth. Generally, it will be present in an amount from about 0.01 to about 2% by weight. The wetting agent acts to improve the contact and leveling properties of the release agent to the mould surface, and is generally present in an amount from about 0.01 to about 2% by weight. The hydrophobic siloxane enhances the hydrophobic properties of a treated surface and, therefore, is added to provide better release properties. This formula used Dow Corning 88 Additive in emulsion form, which is an emulsion form of a silane/siloxane blend with exceptional water resistance. This is present generally in an amount from about 0.1 to about 10% by weight. Finally, the petroleum solvent acts to maintain a proper oil and water phase ratio and enhance performance for the direct release agent. This should be present in an amount from about 1 to about 10% by weight. Generally, the amount of petroleum is minimized to reduce VOCs and improve the environmental profile of the formulations.

The direct release agent is formed by adding the polymeric thickener to the water and mixing this at low speed. Subsequently, the natural oil ester is added at increased mixing speed.

The end product exhibits shear thinning. The release agent can be applied using a variety of different application methods including brushing. For improved efficiency, this is applied to a mould surface using an air spray applicator operating at an air pressure of 3 to 6 bar and a coating pressure of 1 to 3 bar.

The thickness of the release agent as applied to a surface is from about 2 to about 100 microns or more. Immediately upon application of the release agent to the mould surface, the wet concrete can be applied to the mould surface. Once the concrete is sufficiently hardened, the mould can be separated allowing the concrete to cure.

Examples 1 through 5, below, provide the exemplary direct release agent formulations.

### EXAMPLE 1

| | |
|---|---|
| 1. Radia 7961 | 40.0 |
| 2. Solagum USPI* | 0.4 |
| 3. Water DI | 59.6 |

### EXAMPLE 2

| | |
|---|---|
| 1. Radia 7961 | 60.0 |
| 2. Solagum USPI* | 0.5 |
| 3. Water DI | 39.5 |

### EXAMPLE 3

| | |
|---|---|
| 1. Radia 7961 | 40.75 |
| 2. Solagum USPI* | 0.50 |
| 3. Water DI | 49.75 |

*25% actives

### EXAMPLE 4

| Description | Qty mass |
|---|---|
| WATER DEIONIZED | 60.9 |
| Radia 7961 Alkyl (rape seed oil esters) | 37 |
| Radiamould 8200 (fatty esters blend) | 1.5 |
| SOLAGUM SF 306 (polymeric thickener) | 0.3 |
| Byk 349 (wetting agent) | 0.2 |
| Proxel Bd 20 (biocide) | 0.1 |

### EXAMPLE 5

| | |
|---|---|
| 1. Water DI | 59.6 |
| 2. Solagum USPI (25% actives) | 0.4 |
| 3. Radiamould 8200 (fatty esters blend) | 1.7 |
| 4. Radia 7961 (vegetable ester) | 38.0 |
| 5. BYK 349 | 0.2 |
| 6. Proxel BD 20 (biocide) | 0.1 |

Specification of this emulsion:
Appearance: White Viscous Liquid
Sp. Gravity at 20 C.: 0.945-0.950
Viscosity: Brookfield #3 @ 20 rpm: 1250-1750
Solids (at 55 C.): 39-41

An indirect release agent is preferably an oil-in-water emulsion. The oil-in-water emulsion is formed by increasing the water content relative to hydrophobic components, specifically the ester and vegetable oil. Generally, the direct release agent will have an oil content of from about 0 to about 10% by weight. The ester content can be 10 to 90% by weight and preferably 30 to 50% by weight. The total hydrophobic content will be less than 50% by weight.

A typical formulation includes the following formulation shown in Examples 6.

### EXAMPLE 6

| Description | Qty mass |
|---|---|
| WATER DEIONIZED | 45 |
| Biodiesel RME (Biopetrol, Glencore Grain) | 46.66 |
| Fully Refined Rapeseed Oil | 2.2 |
| SOLAGUM SH 210 | 0.2 |
| Byk 349 | 0.06 |
| Exxsol D80 (petroleum solvent) | 4.8 |
| Nuosept 104 (biocide) | 0.08 |
| Dow Corning 88 (hydrophobic siloxane) | 1 |

The indirect release agent can be applied to a mould surface in any manner, such as brushing, spraying, or dipping, but is typically applied with an air sprayer. Preferably, the applied coating will have a film thickness of 2 to 100 microns or more. The emulsion will then, upon application, break, allowing the water to evaporate, leaving behind the oil ester, vegetable oil and the thickener. The viscosity allows the release agent to resist flow and adhere to the mould surface. The uncured concrete is then deposited in contact with the mould surface. After the concrete cures, the mould is separated from the cured concrete.

None of the formulations include any anionic, cationic, nonionic, or any amphoteric surfactant. The substantial absence of the surfactant avoids pitting of the concrete surface while the polymeric thickener maintains the emulsion.

This has been a description of the present invention along with the preferred method of practicing the present invention. However, the invention itself should only be defined by the appended claims, WHEREIN WE CLAIM:

What is claimed is:

1. A water and oil emulsion concrete release agent comprising:
water;
an ester selected from the group consisting of vegetable oil esters, animal oil esters and combinations thereof wherein said ester is liquid at zero degrees centigrade; and
a polymeric thickener.

2. The release agent claimed in claim 1 wherein said ester is a vegetable oil ester.

3. The release agent claimed in claim 2 wherein said vegetable oil ester is a C₅-C₁₂ alkyl ester.

4. The release agent claimed in claim 3 wherein said ester is an ester of rapeseed oil.

5. The release agent claimed in claim 1 wherein said release agent is a direct release agent and said water and oil emulsion is a water-in-oil emulsion having a ratio of water to ester of from 60:40 to 40:60 by weight.

6. The release agent claimed in claim 5 wherein said polymeric thickener is an addition polymer formed from at least one of acrylates, alkylacrylates and anhydrides and having a molecular weight of 1 to 4 million.

7. The release agent claimed in claim 6 wherein said polymeric thickener is present at about 0.01-2% on an actives basis by weight.

8. The release agent claimed in claim 2 wherein the release agent is substantially free of surfactants.

9. The release agent claimed in claim 1 wherein said release agent is an indirect release agent comprising an oil-in-water emulsion.

10. The release agent claimed in claim 9 wherein said thickener comprises an addition polymer formed from at least one of acrylates, alkylacrylates, and anhydrides and having a molecular weight of 1 to 4 million.

11. The release agent claimed in claim 9 further comprising vegetable oil.

12. The release agent claimed in claim 9 wherein said ester comprises vegetable oil ester.

13. The release agent claimed in claim 10 wherein said release agent is substantially free of surfactants.

14. A method of forming concrete comprising applying the release agent of claim 1 to a mould surface;
applying uncured wet concrete against said mound surface;
and allowing said concrete to at least partially cure; and
separating said mould from said concrete.

15. A method of curing concrete comprising applying the release agent of claim 9 to a mould surface, applying concrete against said mould surface and allowing said wet concrete to at least partially cure and separating said mould surface from said concrete.

16. A concrete mould having a mould surface wherein said mould surface is coated with said release agent of claim 1 in an amount effective to prevent curing concrete from sticking to said mould surface.
